(19) United States
(12) Patent Application Publication
(10) Pub. No.: US 2010/0253697 A1
(43) Pub. Date: Oct. 7, 2010

(54) METHODS AND SYSTEMS FOR REMOTELY DISPLAYING ALPHA BLENDED IMAGES

(76) Inventor: Juan Rivera, Doral, FL (US)

Correspondence Address: CHOATE, HALL & STEWART / CITRIX SYSTEMS, INC., TWO INTERNATIONAL PLACE, BOSTON, MA, 02110, US

(21) Appl. No.: 12/728,750

(22) Filed: Mar. 22, 2010

Related U.S. Application Data
(60) Provisional application No. 61/166,967, filed on Apr. 6, 2009.

(51) Int. Cl. G09G 5/02

(52) U.S. Cl. 345/589

(57) ABSTRACT

A blending agent that can determine alpha values of a flattened image, where the flattened image includes at least one image that is generated by a multimedia platform. The blending agent can execute on a local computer to obtain image data that is generated by a first application that executes on the local computer. The blending agent can also obtain image data that is generated by a second application that executes on the local computer. A first graphic can then be rendered in a first color shade using the first application image data, and a second graphic can be rendered in a second color shade using the second application image data. In response to rendering each graphic, the blending agent can determine alpha values for the flattened image.

### RELATED APPLICATIONS

This U.S. patent application claims priority to U.S. Provisional Patent Application Ser. No. 61/166,967, filed on Apr. 6, 2009, the disclosure of which is considered part of the disclosure of this application and is herein incorporated by reference in its entirety.

### FIELD OF THE DISCLOSURE

This disclosure relates generally to remotely displaying graphics. In particular, this disclosure describes determining alpha values associated with blended images.

### BACKGROUND OF THE DISCLOSURE

Desktops can display application graphics by rendering images from draw commands issued by the application. In many instances, two or more applications can issue draw commands to draw a graphic on substantially the same section of the desktop. In these instances, the desktop or a desktop rendering application can alpha blend the images so that the graphic drawn to the desktop is a graphic issued by the dominant application. When one of the two applications is a multimedia application, the output generated by the multimedia application can be alpha blended with output generated by other application or desktop content. The resultant blended image can then be flattened to

In some instances, the graphical application output is blended with content from multimedia applications, desktops or other application content, and flattened. Once the graphical application output is blended and flattened on the server, all the alpha graphics information associated with the graphical application output is lost as a result of the blending and flattening. Thus, when a remote application delivery module on the server sends the graphical application output to the client for rendering, the alpha graphics information is not available for transmission. As a result, the client incorrectly renders an image from the graphical application output because the client did not receive the alpha graphics information from the server.

Losing alpha graphics information due to alpha blending and flattening of graphics output on the server, is a common problem associated with seamless windows displaying on the server. In such a situation, the seamless window is blended into the desktop or server background, and the client is unable to render an image of the seamless window because the alpha graphics information is lost during blending. Another example of where this problem arises is when HTML information is blended on top of FLASH graphical output. In this situation, the HTML graphical information is lost due to blending, therefore when the client renders an image using graphical information transmitted from the server, the HTML image does not appear as it appears on the server because the alpha graphics information was not transmitted to the client. One way to remedy this problem is to have the client push the output of a FLASH player or other multimedia or application object back to the server for proper composition. This solution, however, would take too much time and would affect the user's experience.

In light of the issues posed by alpha blending and image flattening on the server, there is a need for a method or system where alpha graphics information can be recaptured and sent to the client so that the client may render a correct image that substantially matches the image displayed on the server. Further, a need exists for a method and system that accomplishes these tasks without compromising the alpha blending and flattening that occurs on the server.

### SUMMARY OF THE DISCLOSURE

In its broadest interpretation, this disclosure describes methods and systems for determining alpha values and for determining values associated with a first object in an image. When graphics objects or images overlap, alpha blending can occur which includes the blending of a foreground image into a background image. Trying to remotely provide graphics that have been blended into a background image can pose a problem because without the alpha values associated with the blended image, a client machine is unable to draw the foreground image on top of the background image. To address this problem, in one instance an agent or module executing on a server can be provided to intercept the graphical output from an application, and render two different images from the graphical output using two different shades of the same color. Using the color information relating to the two different color shades and the information relating to the resultant color values, alpha values associated with the image as well as the color values of a foreground object are determined. These values can be sent to the client and used to generate an image that correctly draws the foreground image on top of the background image.

In one aspect, described herein is an embodiment of a method for determining alpha values of a flattened image comprising at least one image generated by a multimedia platform. A blending agent executing on a local computer can obtain image data generated by a first application executing on the local computer, and image data generated by a second application executing on the local computer. A first graphic can be rendered in a first color shade using the first application image data. Similarly, a second graphic can be rendered in a second color shade using the second application image data. In response to rendering the first graphic and the second graphic, the blending agent can determine the alpha values for a flattened image that was generated using at least the first application image data and the second application image data.

In some embodiments, a flattened image displayed on the desktop of the local computer can be identified. The flattened image can include a first image section that overlaps a second image section. In one embodiment the blending agent can obtain first application image data that includes information for the first image section of the flattened image, and second application image data that includes information for the second image section of the flattened image.

In another embodiment, the blending agent can determine color information for the first graphic, and color information for the second graphic. The blending agent, in some embodiments, can calculate the alpha values using the first graphic color information, the second graphic color information, the first color shade and the second color shade.

In one embodiment, at least one of the first application or the second application can generate image content using FLASH.

The second graphic, in some embodiments, can be rendered after rendering the first graphic and after waiting a period of time. The second color shade, in some embodiments can be a different shade of the first color shade.

In one embodiment, the local computer can transmit the first application image data, the second application image data and the determined alpha values to a remote computer communicating with the local computer. The remote computer, in some embodiments, can recreate the flattened image of the local computer using the received first application image data, second application image data, and the determined alpha values.

In another aspect, described herein is an embodiment of a system for determining alpha values of a flattened image comprising at least one image generated by a multimedia platform. The system can include a first application that executes on the local computer to generate image data, and a second application that executes on the local computer to generate image data. The system can also include a blending agent that executes on the local computer to obtain the first application image data and the second application image data. The blending agent can also render a first graphic in a first color shade using the first application image data, and a second graphic in a second color shade using the second application image data. In response to rendering the first and second graphic, the blending agent can determine alpha values for the flattened image that was generated using at least the first application image data and the second application image data.

### DETAILED DESCRIPTION OF THE DRAWINGS

The following figures depict certain illustrative embodiments of the methods and systems described herein, where like reference numerals refer to like elements. Each depicted embodiment is illustrative of the methods and systems and not limiting.

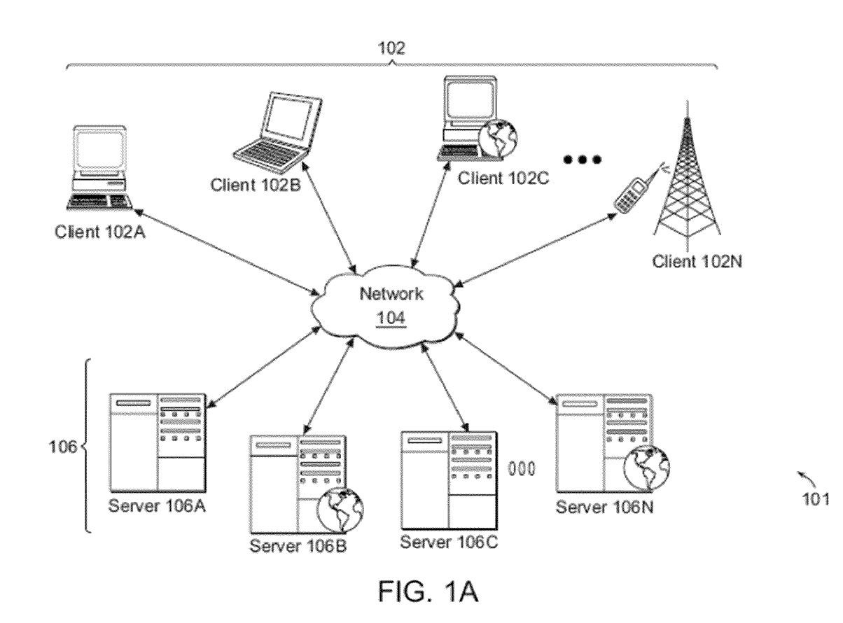

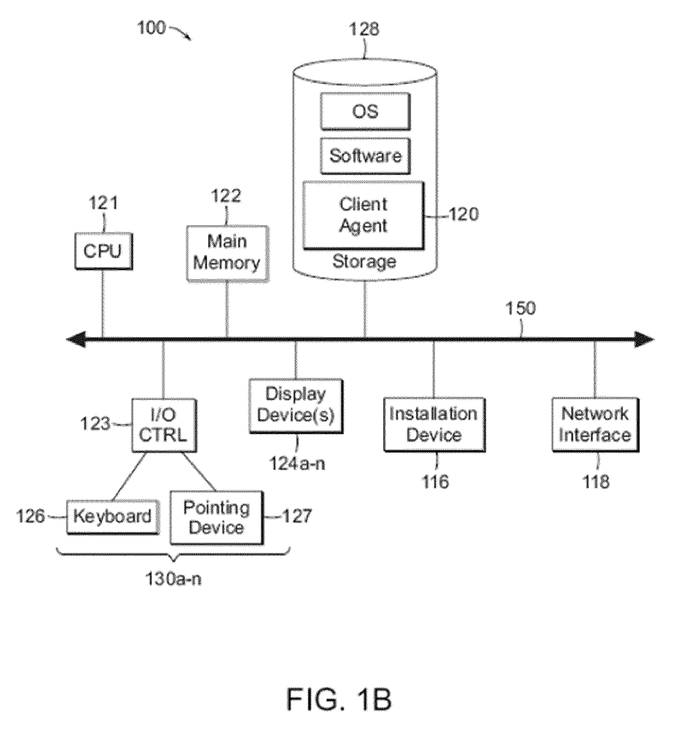

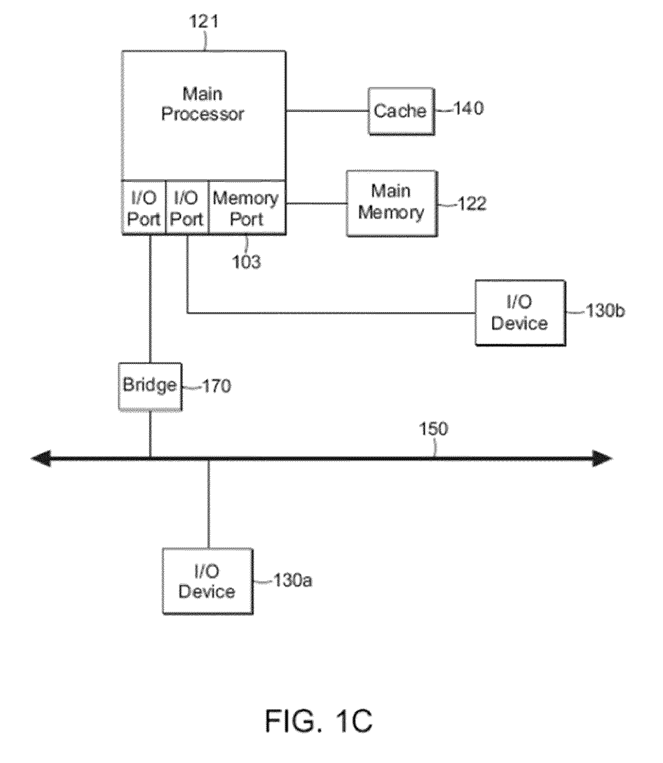

FIG. 1A is a block diagram illustrative of an embodiment of a remote-access, networked environment with a client machine that communicates with a server.

FIGS. 1B and 1C are block diagrams illustrative of an embodiment of computing machines for practicing the methods and systems described herein.

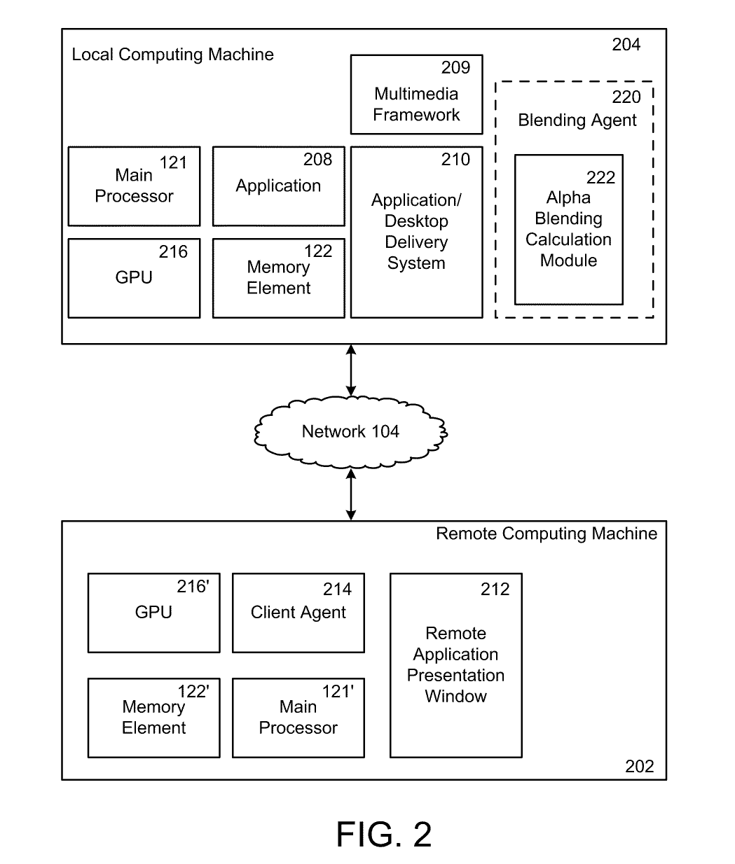

FIG. 2 is a block diagram illustrative of an embodiment of a system for determining alpha information.

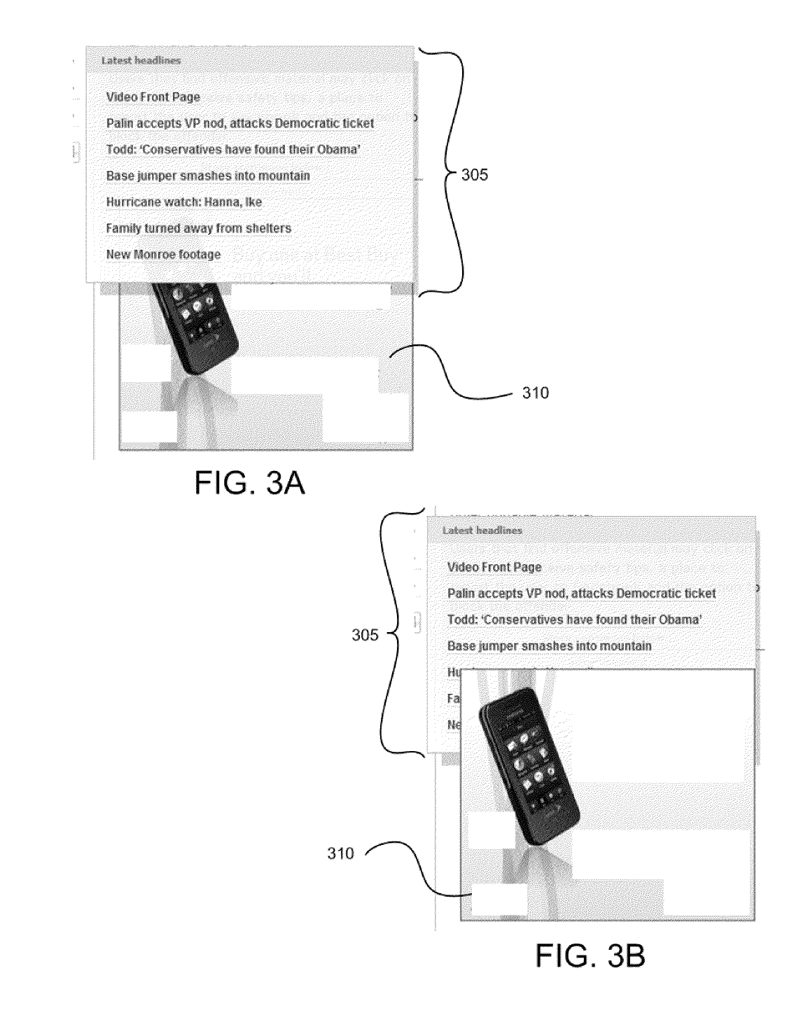

FIGS. 3A-3B are diagrams illustrative of systems that correctly render images using alpha information and systems that incorrectly render images because they do not have alpha information.

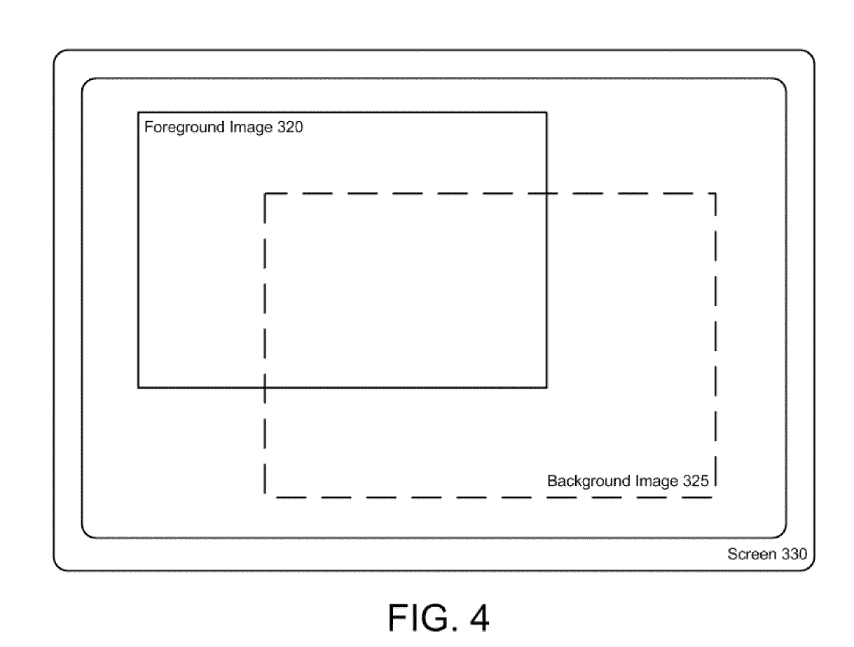

FIG. 4 is a block diagram illustrative of an embodiment of a screen displaying a blended image.

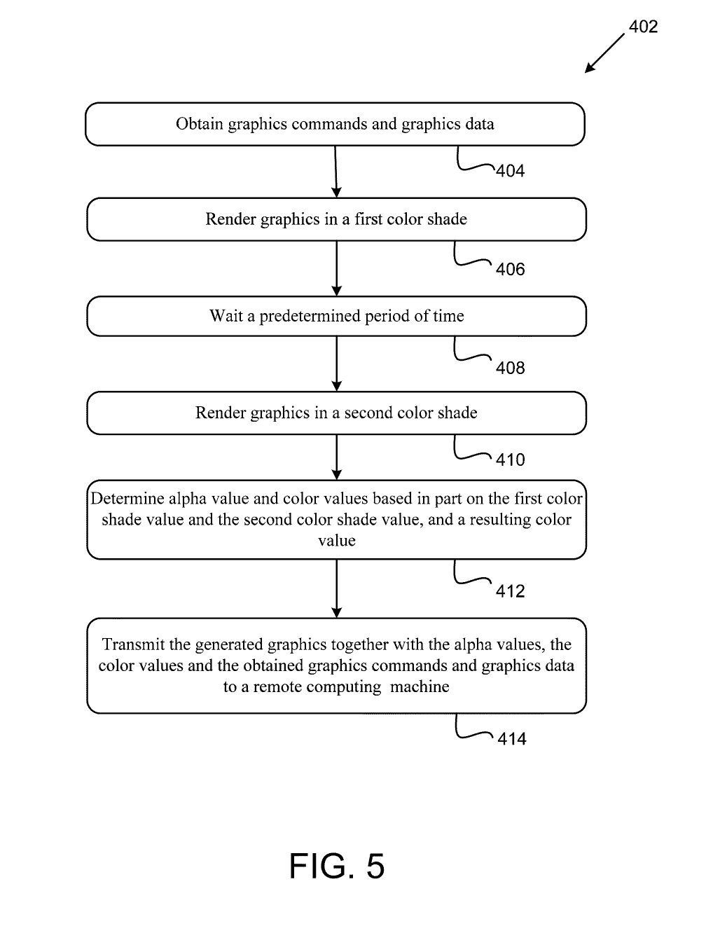

FIG. 5 is a flow diagram illustrative of an embodiment of a method for determining alpha information.

### DETAILED DESCRIPTION

FIG. 1A illustrates one embodiment of a computing environment 101 that includes one or more client machines 102A-102N (generally referred to herein as “client machine(s) 102”) that are in communication with one or more servers 106A-106N (generally referred to herein as “server(s) 106”). Installed in between the client machine(s) 102 and server(s) 106 is a network.

In one embodiment, the computing environment 101 can include an appliance installed between the server(s) 106 and client machine(s) 102. This appliance can mange client/server connections, and in some cases can load balance client connections amongst a plurality of backend servers.

The client machine(s) 102 can in some embodiment be referred to as a single client machine 102 or a single group of client machines 102, while server(s) 106 may be referred to as a single server 106 or a single group of servers 106. In one embodiment a single client machine 102 communicates with more than one server 106, while in another embodiment a single server 106 communicates with more than one client machine 102. In yet another embodiment, a single client machine 102 communicates with a single server 106.

A client machine 102 can, in some embodiments, be referenced by any one of the following terms: client machine(s) 102; client(s); client computer(s); client device(s); client computing device(s); local machine; remote machine; client node(s); endpoint(s); endpoint node(s); or a second machine. The server 106, in some embodiments, may be referenced by any one of the following terms: server(s), local machine; remote machine; server farm(s), host computing device(s), or a first machine(s).

In one embodiment, the client machine 102 can be a virtual machine 102C. The virtual machine 102C can be any virtual machine, while in some embodiments the virtual machine 102C can be any virtual machine managed by a hypervisor developed by XenSolutions, Citrix Systems, IBM, VMware, or any other hypervisor. In other embodiments, the virtual machine 102C can be managed by any hypervisor, while in still other embodiments, the virtual machine 102C can be managed by a hypervisor executing on a server 106 or a hypervisor executing on a client 102.

The client machine 102 can in some embodiments execute, operate or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. Still other embodiments include a client device 102 that displays application output generated by an application remotely executing on a server 106 or other remotely located machine. In these embodiments, the client device 102 can display the application output in an application window, a browser, or other output window. In one embodiment, the application is a desktop, while in other embodiments the application is an application that generates a desktop.

The server 106, in some embodiments, executes a remote presentation client or other client or program that uses a thin-client or remote-display protocol to capture display output generated by an application executing on a server 106 and transmits the application display output to a remote client 102. The thin-client or remote-display protocol can be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash.

The computing environment can include more than one server 106A-106N such that the servers 106A-106N are logically grouped together into a server farm 106. The server farm 106 can include servers 106 that are geographically dispersed and logically grouped together in a server farm 106, or servers 106 that are located proximate to each other and logically grouped together in a server farm 106. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

In some embodiments, a server farm 106 can include servers 106 that execute a substantially similar type of operating system platform (e.g., WINDOWS NT, manufactured by Microsoft Corp. of Redmond, Wash., UNIX, LINUX, or SNOW LEOPARD.) In other embodiments, the server farm 106 can include a first group of servers 106 that execute a first type of operating system platform, and a second group of servers 106 that execute a second type of operating system platform. The server farm 106, in other embodiments, can include servers 106 that execute different types of operating system platforms.

The server 106, in some embodiments, can be any server type. In other embodiments, the server 106 can be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 executing an active directory; or a server 106 executing an application acceleration program that provides firewall functionality, application functionality, or load balancing functionality. In some embodiments, a server 106 may be a RADIUS server that includes a remote authentication dial-in user service. In embodiments where the server 106 comprises an appliance, the server 106 can be an appliance manufactured by any one of the following manufacturers: the Citrix Application Networking Group; Silver Peak Systems, Inc; Riverbed Technology, Inc.; F5 Networks, Inc.; or Juniper Networks, Inc. Some embodiments include a first server 106A that receives requests from a client machine 102, forwards the request to a second server 106B, and responds to the request generated by the client machine 102 with a response from the second server 106B. The first server 106A can acquire an enumeration of applications available to the client machine 102 and well as address information associated with an application server 106 hosting an application identified within the enumeration of applications. The first server 106A can then present a response to the client's request using a web interface, and communicate directly with the client 102 to provide the client 102 with access to an identified application.

The server 106 can, in some embodiments, execute any one of the following applications: a thin-client application using a thin-client protocol to transmit application display data to a client; a remote display presentation application; any portion of the CITRIX ACCESS SUITE by Citrix Systems, Inc. like the METAFRAME or CITRIX PRESENTATION SERVER; MICROSOFT WINDOWS Terminal Services manufactured by the Microsoft Corporation; or an ICA client, developed by Citrix Systems, Inc. Another embodiment includes a server 106 that is an application server such as: an email server that provides email services such as MICROSOFT EXCHANGE manufactured by the Microsoft Corporation; a web or Internet server; a desktop sharing server; a collaboration server; or any other type of application server. Still other embodiments include a server 106 that executes any one of the following types of hosted servers applications: GOTOMEETING provided by Citrix Online Division, Inc.; WEBEX provided by WebEx, Inc. of Santa Clara, Calif.; or Microsoft Office LIVE MEETING provided by Microsoft Corporation.

Client machines 102 can, in some embodiments, be a client node that seeks access to resources provided by a server 106. In other embodiments, the server 106 may provide clients 102 or client nodes with access to hosted resources. The server 106, in some embodiments, functions as a master node such that it communicates with one or more clients 102 or servers 106. In some embodiments, the master node can identify and provide address information associated with a server 106 hosting a requested application, to one or more clients 102 or servers 106. In still other embodiments, the master node can be a server farm 106, a client 102, a cluster of client nodes 102, or an appliance.

One or more clients 102 and/or one or more servers 106 can transmit data over a network 104 installed between machines and appliances within the computing environment 101. The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; or a network 104 that includes a wireless link where the wireless link can be an infrared channel or satellite band. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices.

Illustrated in FIG. 1B is an embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines, and a client agent 120. The I/O controller 123, in some embodiments, is further connected to a key board 126, and a pointing device 127. Other embodiments may include an I/O controller 123 connected to more than one input/output device 130A-130N.

FIG. 1C illustrates one embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a bridge 170, and a first I/O device 130A. In another embodiment, the bridge 170 is in further communication with the main central processing unit 121, where the central processing unit 121 can further communicate with a second I/O device 130B, a main memory 122, and a cache memory 140. Included within the central processing unit 121, are I/O ports, a memory port 103, and a main processor.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1C illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121, may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include a graphics processor or a graphics processing unit (Not Shown). The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 can, in some embodiments, also be used by the central processing unit to communicate with more than one type of I/O device 130A-130N. In some embodiments, the local system bus 150 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 100 include an I/O device 130A-130N that is a video display 124 that communicates with the central processing unit 121. Still other versions of the computing machine 100 include a processor 121 connected to an I/O device 130A-130N via any one of the following connections: HyperTransport, Rapid I/O, or InfiniBand. Further embodiments of the computing machine 100 include a processor 121 that communicates with one I/O device 130A using a local interconnect bus and a second I/O device 130B using a direct connection.

The computing device 100, in some embodiments, includes a main memory unit 122 and cache memory 140. The cache memory 140 can be any memory type, and in some embodiments can be any one of the following types of memory: SRAM; BSRAM; or EDRAM. Other embodiments include cache memory 140 and a main memory unit 122 that can be any one of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); or any other type of memory. Further embodiments include a central processing unit 121 that can access the main memory 122 via: a system bus 150; a memory port 103; or any other connection, bus or port that allows the processor 121 to access memory 122.

One embodiment of the computing device 100 provides support for any one of the following installation devices 116: a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 100 includes a network interface 118 able to communicate with additional computing devices 100′ via any type and/or form of gateway or tunneling protocol such as Secure Socket Layer (SSL) or Transport Layer Security (TLS), or the Citrix Gateway Protocol manufactured by Citrix Systems, Inc. Versions of the network interface 118 can comprise any one of: a built-in network adapter; a network interface card; a PCMCIA network card; a card bus network adapter; a wireless network adapter; a USB network adapter; a modem; or any other device suitable for interfacing the computing device 100 to a network capable of communicating and performing the methods and systems described herein.

Embodiments of the computing device 100 include any one of the following I/O devices 130A-130N: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB FLASH Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can connect to multiple display devices 124A-124N, in other embodiments the computing device 100 can connect to a single display device 124, while in still other embodiments the computing device 100 connects to display devices 124A-124N that are the same type or form of display, or to display devices that are different types or forms. Embodiments of the display devices 124A-124N can be supported and enabled by the following: one or multiple I/O devices 130A-130N; the I/O controller 123; a combination of I/O device(s) 130A-130N and the I/O controller 123; any combination of hardware and software able to support a display device 124A-124N; any type and/or form of video adapter, video card, driver, and/or library to interface, communicate, connect or otherwise use the display devices 124A-124N. The computing device 100 may in some embodiments be configured to use one or multiple display devices 124A-124N, these configurations include: having multiple connectors to interface to multiple display devices 124A-124N; having multiple video adapters, with each video adapter connected to one or more of the display devices 124A-124N; having an operating system configured to support multiple displays 124A-124N; using circuits and software included within the computing device 100 to connect to and use multiple display devices 124A-124N; and executing software on the main computing device 100 and multiple secondary computing devices to enable the main computing device 100 to use a secondary computing device's display as a display device 124A-124N for the main computing device 100. Still other embodiments of the computing device 100 may include multiple display devices 124A-124N provided by multiple secondary computing devices and connected to the main computing device 100 via a network.

In some embodiments, the computing machine 100 can execute any operating system, while in other embodiments the computing machine 100 can execute any of the following operating systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; and WINDOWS VISTA; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS or another virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the computing machine 100 can be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. In still other embodiments, the computing device 100 can be any one of the following mobile computing devices: any one series of Blackberry, or other handheld device manufactured by Research In Motion Limited; the iPhone manufactured by Apple Computer; Palm Pre; a Pocket PC; a Pocket PC Phone; or any other handheld mobile device.

Illustrated in FIG. 2 is an embodiment of a system that can determine alpha image values for a blended and flattened image. The system can include a remote computing machine 202 that communicates with one or more local computing machines 204. The local computing machine 204 or local computer 204, can include a main processor 121, a graphics processing unit (GPU) 216, a memory element 122, and an application/desktop delivery system 210. The local computer 204 can execute one or more applications 210, and can execute a blending agent 220, which can further include alpha blending calculation module 222. The local computer 204 can communicate with the remote computing machine 202, or remote computer 202, over a network 104. In some aspects, the remote computer 202 can include a GPU 216′, a memory element 122′, and a main processor 121′. The remote computer 202 can execute a client agent 214 and a remote application presentation window 212.

Referring to FIG. 2, and in more detail, in one embodiment the local computing machine 204 and the remote computing machine 202 can be any computing device 100 described herein. In another embodiment, the local computing machine 204 can be a server 106 while the remote computing machine 202 can be a client 102. The local computing machine 204 can be referred to as any of the following: local computer; server; computer; computing device; machine; first computing device; second computing device; or any other similar phrase. The remote computing machine 202 can be referred to as any of the following: remote computer; client; computer; computing device; machine; first computing device; second computing device; or any other similar phrase. In some embodiments, the local computing machine 204 and the remote computing machine 202 communicate over a communication channel established over the network 104. Each computing machine can communicate with the other computing machine using a presentation level protocol. In some embodiments, this protocol can be the ICA protocol developed by CITRIX SYSTEMS INC.

Each of the local computing machine 204 and the remote computing machine 202 contain a: memory element 122, 122′; main processor 121, 121′; and a GPU 216, 216′. The memory element 122, 122′ and the main processor 121, 121′ can be any of the memory elements and processors described herein. The GPU (Graphical Processing Unit) can in some embodiments be a hardware component dedicated to processing graphics commands, while in other embodiments, the GPU can be a set of executable commands, or executable program able to process graphics commands. In one embodiment, the GPU 216, 216′ can be referred to a graphics processor. In some embodiments, the local computing machine 204 and the remote computing machine 202 may include a three-dimensional graphics library (not shown) that may be associated with Direct3D, OPEN GL or other three-dimensional graphics Application Program Interface (API). Embodiments where a graphics library is included may further include a GPU 216, 216′ that interfaces with the graphics library to render graphics.

In one embodiment, the local computing machine 204 executes an application 208 that generates application output. The application output can comprise graphical data that is then display on a display device connected to the local computing machine 204. Users of the remote computing machine 204 can access the application output and control the application 208 via a remote delivery system 210 that captures the application output as it is generated by the application 208 and transmits the application output to the remote computing machine 202 where it is rendered for display on a screen of a display device connected to the remote computing machine 202. The application 208 can be any of the following: a desktop; a set of commands; an application executable on a device connected to the local computing machine 204; and any other application able to be executed by the local computing machine 204.

Either the local computer 204 or the remote computer 202, in some embodiments, can execute one or more applications 208. Although FIG. 2 illustrates computers 202, 204 that execute a single application 208, in some embodiments the computers 202, 204 can execute one, two or more applications 208. For example, a first and second application 208′, 208″, can execute on one of the computers 202, 204 to generate image data or graphics information. In many embodiments, the image data can be transmitted to the GPU 216 which can render images and graphics from the image data. In other embodiments, the blending agent 220 can intercept the image data before it is received by the GPU 216.

In another embodiment the local computing machine 204 can execute an application/desktop delivery system 210 that intercepts application output generated by the application 208 executing on the local computing machine 204 and transmits the application output to a remote computing device 202 where it is received by a client agent 214 executing on the remote computing device 202. The application/desktop delivery system 210 can transmit the intercepted application output over a communication channel that the application/desktop delivery system 210 establishes between the local computing machine 204 and the remote computing machine 202. Further, in some embodiments, the application/desktop delivery system 210 can transmit the intercepted application output using a presentation level protocol. In one embodiment, the application/desktop delivery system 210 receives user commands and other user-generated input from the client agent 214. Once the user commands are received by the application/desktop delivery system 210, they can be forwarded to the application 208 where they are processed.

In yet another embodiment, the remote computing machine 202 can execute a client agent 214 that receives graphics information and application output transmitted by the application/desktop delivery system 210 via a communication channel established between the local computing machine 204 and the remote computing machine 202 and over the network 104. Once the client agent 214 receives the graphics information and application output, the client agent 214 can, in some embodiments, send the graphics information to the GPU 216′ for rendering and transmit additional information to a remote application presentation window 212 executing on the remote computing machine 202. In some embodiments, the client agent 214 can intercept user commands and other user-related data and send this data to the application/desktop delivery system 210 on the local computing machine 204. Once the data is rendered by the GPU, the resulting graphics can be displayed within the remote application presentation window 212 which can in some instances be configured to resemble the application 208 executing on the local computing machine 204.

The local computer 204, in some embodiments, can execute a multimedia framework 209 that can be used to generate graphics, video and other multimedia content. In some embodiments, the multimedia framework 209 can execute in conjunction with another application 208 executing on the local computer 204 to generate application output. For example, the multimedia framework 209 can be a plugin that can execute in conjunction with an application 208 such as INTERNET EXPLORER; MOZILLA; GOOGLE CHROME; SAFARI; ADOBE; any application that is part of the MICROSOFT OFFICE SUITE; and any other application that can execute in conjunction with a multimedia framework 209. In some embodiments, the multimedia framework 209 can be a FLASH player, in other embodiments the multimedia framework 209 can be JAVAFX; SYNFIG; OPENLASZLO; MICROSOFT SILVERLIGHT; or any other type of multimedia framework.

In some embodiments, the local computer 204 can execute a blending agent 220 that can be used to determine the alpha values for a flattened image displayed on a desktop of the local computer 204. In one embodiment, the blending agent 220 can interact with the multimedia framework 209, to obtain graphics commands and images. The obtained graphics information, in some embodiments, can be destined for display on a desktop of the local computer 204. For example, an application in conjunction with the multimedia framework 209 can generate graphics commands and images, and transmit those commands and images to a desktop manager for display. The desktop manager can then render a graphic or image from the graphics commands and images generated by the application, and can display the rendered graphic on a desktop of the local computer 204 that is displayed on a display device or monitor of the local computer 204. When an image is displayed on a desktop, in some embodiments this image can be referred to as a flattened image. The image, in some embodiments, can include multiple image sections that when displayed as a single image on a desktop, can be referred to as a blended, flattened image.

In some embodiments, the blending agent 220 can intercept the graphics commands and images before they are rendered and displayed. In other embodiments, the blending agent 220 can retrieve the graphics commands and images from the desktop manager, or from a buffer, cache or other storage repository. The blending agent 220, in some embodiments, can query the desktop manager or another desktop rendering application, for the graphics commands and images associated with a displayed, flattened image.

The blending agent 220, in some embodiments, can be a control, a program, or an ACTIVEX proxy control that intercepts output generated by the multimedia framework 209 and forwards the intercepted output to a GPU for rendering or an application for processing. In one embodiment, the blending agent 220 can determine the alpha values for images generated from the graphics commands, images and other graphics information intercepted by the blending agent 220. In one embodiment, the blending agent 220 can determine the alpha values for flattened and/or blended images displayed on a desktop. Determining alpha values or alpha information can include determining the alpha information lost during blending and flattening of one or more image sections. In particular, the blending agent 220 can determine the alpha values for an image created by blending and flattening graphics output generated using the multimedia framework 209 and graphics output generated by an application 208.

The process by which the blending agent 220 retrieves the lost alpha information can include rendering one image in a first color shade and then rendering a second image in a second color shade. The color shade can be any shade of any color. In some embodiments, the color can be a gray color and the shade can be a shade of gray. By rendering the images in two different color shades, the resultant color along with the two different color shades can be used to determine the alpha color information and the color information for the blended and flattened graphic. The blending agent 220, in some embodiments, can wait a period of time after rendering the first image before rendering the second image. This period of time can be predetermined or can be based on system latency. In one embodiment, the period of time can be a time period within the range of 10 ms. to 100 ms.

While in some embodiments the blending agent 220 can calculate or determine the alpha values, in other embodiments the blending calculation module 222 can determine the alpha values. The blending calculation module 222 can be a sub-program, or function that executes within the context of the blending agent 220. In other embodiments, the alpha blending calculation module 222 can execute outside of the blending agent 220. In these embodiments, the alpha blending calculation module 222 can receive image information and color shade information from the blending agent 220. Using this received information, the alpha blending calculation module 222 can calculate or otherwise determine the alpha color information for a flattened image that include at least two images where one of the images is an image generated by a multimedia application or framework 209.

The alpha blending calculation module 222 can, in some embodiment execute on the local computer 204. In other embodiments, the alpha blending calculation module 22 may execute on a remote computer and communicate with the blending agent 220 via a network 104 connection. In some embodiments, the alpha blending calculation module 222 can receive color information for the two color shades used to render the two images, and can also receive the resulting color information of the rendered images. Using this information, the alpha blending calculation module 222 can calculate the alpha color information of the flattened image using the following formula or mathematical relationship, R=(1−α)H+α(F), where R is the resulting color information of the rendered graphic, α is the alpha value information, H is the color information associated with the blended and flattened graphic, and F is the color shade information. Using this equation, the blending calculation module 222 can calculate the alpha information (α), the HTML color, or the color of the image lost during blending (H).

Illustrated in FIG. 3A is an embodiment of a diagram where alpha pixel values were used to draw a HTML menu on top of FLASH output, and create a flattened image. FIG. 3B illustrates an embodiment of a diagram where alpha pixel values were not available, therefore when the FLASH content and the HTML menu are transmitted to a remote computer, the computer is unable to accurately draw the HTML menu on top of the FLASH content as was done in FIG. 3A. In particular, FIG. 3B illustrates an HTML menu blended into the background and therefore no longer properly displayed on top of the image generated by the FLASH player. In FIG. 3A, FLASH content 310 is drawn to the desktop, a HTML menu 305 is then opened on top of the FLASH content 310 and is therefore drawn to the desktop as a window opened on top of the FLASH content 310. FIG. 3B represents the graphics information displayed in FIG. 3A after it has been gathered using typical remoting techniques and sent to the client or remote computing machine 202 for rendering. After the output is rendered, the HTML menu 305 is no longer drawn on top of the FLASH content 310. Instead, the FLASH content 310 is drawn on top of the HTML menu 305 so that the HTML menu 305 is no longer visible.

Further referring to FIG. 3A and in more detail, illustrated in FIG. 3A is the graphical representation of the FLASH player output and HTML output that is displayed at a local computing machine 204. In one embodiment, FIG. 3A illustrates an instance where FLASH content 310 is displayed, and while displaying the FLASH content 310, an HTML 305 menu is displayed on the desktop. At the local computing machine 204, the alpha information associated with the HTML menu 305 is available such that the local computing machine 204 can correctly draw the HTML menu 305 on top of the FLASH content 310. When the HTML menu 305 is drawn on top of the FLASH content 310, the HTML menu 305 is blended and flattened. Thus, the alpha information associated with the HTML menu 305 is lost.

The flattened image displayed in FIG. 3A can include a rendered image of the HTML menu 305 and a rendered image of the FLASH content 310. These rendered images are images that are generated from graphics information or image data generated by an application. For example, the HTML menu 305 image can be an image 305 rendered from drawing commands and images outputted by an HTML application. The FLASH content 310 image can an image 310 rendered from drawing commands and images outputted by a FLASH player.

In some embodiments, each image 305, 310 generated from application output can have color information. This color information can include the color values of the pixels included in each image 305, 310. For example, the HTML image 305 can include a group of pixels where each pixel has at least a color value and an intensity value. Similarly, the FLASH image 310 can include a group of pixels where each pixel has at least a color value and an intensity value. Thus, when the blending agent 220 obtains color information for images displayed on the desktop, the color information can include the color values and/or the intensity values of the pixels included in each image.

Further referring to FIG. 3B and in more detail, the flattened image illustrated in FIG. 3B is a representation of what is drawn when the blended graphics information generated in FIG. 3A is sent to a remote computer or client. As stated previously, when the HTML menu 305 is drawn on top of the FLASH content 310 on the local computer or server, the alpha information for each image is used to create a flattened image. Thus, the alpha information associated with the HTML menu 305 is used to create a blended, flattened image. When the images 305, 310 are transmitted to a remote computer or client, the alpha information for the HTML menu 305 is often not transmitted along with the HTML menu 305 image. Rather the alpha information may be lost and therefore cannot be used to properly redraw the flattened image to display the HTML menu image 305 on top of the FLASH content image 310. The local computing device 204 was able to use the alpha information to correctly draw the HTML menu 305 on top of the FLASH content 310. In FIG. 3B, the alpha information associated with the HTML menu 305 is not transmitted to the remote computing device 202, so the HTML menu 305 collapses into the background and the FLASH player 310 is drawn on top of the HTML menu 305.

While FIGS. 3A-3B illustrate images 305, 310 that are generated by a HTML application and a FLASH player, in other embodiments the images 305, 310 can be generated by any application. In one embodiment, the applications can be applications that generate application windows that use AERO GLASS technology or any other technology that can generate application output windows that use the AERO GLASS technique. When windows that use the AERO GLASS technique are displayed on the desktop of a local computer 204, the windows are blended together so that the outer edges of the top window are transparent enough to view a window underneath the top window. In this embodiment, the blending agent 220 can obtain the alpha image values for both the top window and the bottom window so that when the application output data is transmitted to a remote computer, the remote computer can display the windows as they were displayed on the local computer.

Illustrated in FIG. 4 is a screen 330 that displays a background image 325 and a foreground image 320. In most computing environments, when multiple objects or images are displayed on a particular screen 330, the possibility exists that those objects or images will overlap. When overlapping occurs, the desktop manager or other graphics manager reconciles between multiple images which image should be in the foreground and which image should be in the background. To accomplish this, most applications will generate alpha data, alpha information or alpha values. When images are drawn on top of each other, alpha blending occurs which is the combination of the colors of one image with the colors of another image according to a transparency associated with each set of colors. The alpha value(s) identifies which image should be transparent, which pixels within the image should be transparent and the degree of transparency. Thus, if the foreground image 320 has alpha information associated with it that directs the foreground image 320 to be completely opaque, while the background image 325 has alpha information associated with it that directs the background image 325 to be partially transparent, the resulting image will display all of the foreground image 320 and only the portion of the background image 325 not covered by the foreground image 320. Without the alpha information, it is likely that one or both of the images may collapse into the background image.

Illustrated in FIG. 5 is an embodiment of a method 402 for determining the alpha values and color values associated with a blended and flattened image. A blending agent 220 intercepts graphics commands and graphics data generated by two or more applications executing on a local computer 204 (Step 404.) The blending agent 220 then renders graphics in a first color shade (Step 406), waits for a predetermined period of time (Step 408,) and renders graphics in a second color shade (Step 410.) Once each of a first set of graphics and a second set of graphics have been rendered, an alpha blending calculation module 222 determines alpha values and color values associated with each rendered image based in part on the first and second color shade, and the resulting colors of the first and second set of graphics (step 412). The rendered graphics together with the determined alpha and color values are sent by the application/desktop delivery system 210 to a remote computing machine 202 communicating with the local computing machine 204 (step 414).

Further referring to FIG. 5 and in more detail, in one embodiment, the method 402 can include permitting the blending agent 220 to obtain the graphics commands and graphics data (Step 404) generated by at least two applications 208 executing on the local computing machine 204. In one instance, the blending agent 220 accomplishes this task by hooking into the desktop manager and intercepting any draw commands and/or images generated and issued by the applications 208. In another instance, the applications 208 can transmit the draw commands and/or images directly to the blending agent 220. In still other embodiments, the blending agent 220 can obtain the draw commands and/or images generated by the applications 208 from a storage repository such as a local cache or image buffer.

Once the blending agent obtains the graphics commands and the graphics data (Step 404), the blending agent then renders graphics in a first color shade (Step 406), waits a predetermined period of time (Step 408), and renders graphics in a second color shade (Step 410). The blending agent 220 can render the graphics for each application 208 in a first and second color shade. In some embodiments, the color shades can be different hues of the same color. In still other embodiments, the color shades can be different intensities of the same color. The color can be any color, and the shades can be any hue of any color. In one embodiment, the second color shade is a different shade of the color of the first color shade. For example, the color shades can be two different shades of gray.

In some embodiments this first color shade is predetermined by being hardcoded into the blending agent 220, while in other embodiments, the first color shade is selected from a database. In some embodiments, an application dictates which color the blending agent 220 should use to render the image, while in others, the user dictates the color. When the blending agent 220 generates the image in the first predetermined color shade, the blending agent 220 can further analyze the resulting image to determine one or more resultant colors. The resultant color values can either be stored in memory or inputted directly into the alpha blending calculation module 222.

Once the first image or set of images has been rendered, the blending agent 220 may wait a predetermined amount of time. In one embodiment, this amount of time is hard-coded into the blending agent 220, while in other embodiments, the user or application dictates the time length. Still other embodiments include an agent that determines the time period based on environmental values and/or based on other system input. A time module (not shown) within the blending agent 220 may track the time so that the blending agent 220 waits the predetermined period of time. The predetermined period of time can be anywhere from 10 milliseconds to 100 milliseconds. In some embodiments the period of time can be substantially 0 milliseconds, while in other embodiments, the period of time may be greater than 100 milliseconds.

In one embodiment, once the blending agent 220 waits for the predetermined period of time, the blending agent 220 then renders a second image or set of images in a second shade of the color (Step 410). The second color shade is, in one embodiment, a different shade of the color used to render the first image or set of images. The second color shade may be either a light or darker shade of the color used to render the first image or set of images. In some embodiments, the blending agent 220 could render the second image or set of images in response to an event rather than after a predetermined period of time. Once the second image or set of images is rendered, the blending agent 220 can further analyze the resulting image to determine one or more result colors. The resultant color values can either be stored in memory or inputted directly into the alpha blending calculation module 222.

Once the blending agent 220 has generated both images, the alpha blending calculation module 222 uses the two color shades used to generate both images and the resultant color from both images to calculate or guess the alpha values and the values associated with the first image. In one embodiment, the alpha blending calculation module 222 uses the following relationship to determine these values: R=(1−α)H+α(F) where R is the resultant color of each image, α is the alpha value, H is the color value of a first object within the first and second image and F is the color value of a second object within the first and second image. A first R′ value and a first F′ value are generated when the first image is rendered. A second R″ value and a second F″ value are generated when the second image is rendered. Thus, the following equation can be used by the alpha blending calculation module 222 to determine the alpha value, (R′−R″)/(F′−F″). While the following equation can be used by the alpha blending calculation module 222 to determine the color value of the first object (H), (C′−(α*C″))/(1−α). The alpha blending calculation module 222 can therefore use these equations to calculate the H and α values. In one embodiment, the first object is an HTML menu or other object that has been blended such that when the image is transmitted to the client, the object collapses into the background. In this embodiment, the second object (F) can be the FLASH content.

Once the alpha values and the color values associated with the first object are determined, either the blending agent 220 or the application/desktop delivery system 210 can transmit (Step 414) these values together with the obtained graphics commands and graphics data to a remote computing machine 202. In one embodiment the remote computing machine 202 can render a bitmap using the alpha values, the color values associated with the first object, the graphics commands and the graphics data, while in other embodiments, a bitmap is generated on the local computing machine 204 and transmitted to the remote computing machine 202.

When the alpha values and the color values of the first and second image or object are transmitted to the remote computer 202 (Step 414), in some embodiments the remote computer 202 can redraw the flattened image displayed on the local computer 204 upon receiving the alpha values and the color values. Thus, when the remote computer 202 receives the alpha and color values from the local computer 204, the remote computer 202 can use these values in conjunction with the draw commands issued by the applications that generated the foreground and background image, to redraw the flattened image displayed on the local computer 204. The received alpha values and color values of the images permit the remote computer 202 to draw the foreground image so that it is displayed on top of the background image.

In one embodiment, the method 402 described in FIG. 5 can be altered to accommodate the situation that arises when graphics content changes while the blending agent 220 flips the rendering colors to render the second image in a second color shade. When this occurs, the alpha blending calculation module 222 cannot correctly determine the alpha values and the color values associated with the first object in the image. In such a situation, the blending agent 220 can detect a change in the object's graphical or textual composition and can drop the calculated alpha values. Dropping the alpha values can occur either in response to a change in the object's graphical or textual composition, or in response to an error check performed by the blending agent 220 prior to sending the alpha values and H values to the application/desktop delivery system 210 for transmission to a remote computing machine 202. In another embodiment, the blending agent 220 can halt executing on the alpha value detection process and can resume the process only upon determining that the graphical and textual composition of the first object has not changed for a predetermined period of time.

The present disclosure may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, a computer readable medium having instructions executable by a processor, or a magnetic tape. In general, the computer-readable programs may be implemented in any programming language. Some examples of languages that can be used include C, C++, C#, or JAVA. The software programs may be stored on or in one or more articles of manufacture as object code.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompany claims and their equivalents.

What is claimed is:

1. A method for determining alpha values of a flattened image comprising at least one image generated by a multimedia platform, the method comprising:
obtaining, by a blending agent executing on a local computer, image data generated by a first application executing on the local computer;
obtaining, by the blending agent, image data generated by a second application executing on the local computer, wherein at least one of the first application and the second application is a multimedia platform;
rendering a first graphic in a first color shade using the first application image data;
rendering a second graphic in a second color shade using the second application image data; and
determining, by the blending agent responsive to rendering the first graphic and the second graphic, alpha values for a flattened image generated using at least the first application image data and the second application image data.

2. The method of claim 1, further comprising identifying a flattened image displayed on a desktop of the local computer, the flattened image comprising a first image section overlapping a second image section.

3. The method of claim 2, wherein obtaining first application image data further comprises obtaining image data for the first image section of the flattened image, and wherein obtaining second application image data further comprises obtaining image data for the second image section of the flattened image.

4. The method of claim 1, further comprising determining color information for the first graphic, and color information for the second graphic.

5. The method of claim 4, wherein determining the alpha values further comprises calculating the alpha values using the first graphic color information, the second graphic color information, the first color shade and the second color shade.

6. The method of claim 1, wherein at least one of the first application and the second application generates image content using FLASH.

7. The method of claim 1, wherein rendering the second graphic further comprises rendering the second graphic after rendering the first graphic and after waiting a period of time.

8. The method of claim 1, wherein rendering the second graphic in a second color shade further comprises rendering the second graphic in a different shade of the first color shade.

9. The method of claim 1, further comprising transmitting the first application image data, the second application image data and the determined alpha values to a remote computer communicating with the local computer.

10. The method of claim 9, further comprising recreating, by the remote computer the flattened image of the local computer using the received first application image data, second application image data, and the determined alpha values.

11. A system for determining alpha values of a flattened image comprising at least one image generated by a multimedia platform, the system comprising:
a first application executing on a local computer to generate image data;
a second application executing on the local computer to generate image data; and
a blending agent executing on the local computer to:
obtain the first application image data,
obtain the second application image data,
render a first graphic in a first color shade using the first application image data,
render a second graphic in a second color shade using the second application image data, and
determine, responsive to rendering the first graphic and the second graphic, alpha values for a flattened image generated using at least the first application image data and the second application image data.

12. The system of claim 11, further comprising the flattened image displayed on a desktop of the local computer, and comprising a first image section overlapping a second image section.

13. The system of claim 12, wherein the first application image data comprises image data for the first image section of the flattened image, and the second application image data comprises image data for the second image section of the flattened image.

14. The system of claim 11, wherein the blending agent determines color information for the first graphic, and color information for the second graphic.

15. The system of claim 14, wherein the blending agent determines the alpha values using the first graphic color information, the second graphic color information, the first color shade and the second color shade.

16. The system of claim 11, wherein at least one of the first application and the second application generates image content using FLASH.

17. The system of claim 11, wherein the blending agent renders the second graphic after rendering the first graphic and after waiting a period of time.

18. The system of claim 11, wherein the second color shade is a different shade of the first color shade.

19. The system of claim 11, wherein the local computer transmits the first application image data, the second application image data and the determined alpha values to a remote computer communicating with the local computer.

20. The system of claim 19, wherein the remote computer recreates the flattened image of the local computer using the received first application image data, second application image data, and the determined alpha values.
